(19) United States
(12) Patent Application Publication
(10) Pub. No.: US 2003/0214664 A1
(43) Pub. Date: Nov. 20, 2003

(54) Programmable printer function keys

(76) Inventor: John Moffatt, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/150,431

(22) Filed: May 17, 2002

(51) Int. Cl. B41J 1/00; G06F 15/00; G06K 1/00

(52) U.S. Cl. 358/1.13; 358/1.16

(57) ABSTRACT

A printing device has a programmable function key that can be reprogrammed with user-defined functionality. A key sequence may be entered to start the recording of a functional sequence. The functional sequence is assigned to the programmable function key so that when the programmable function key is activated, the functional sequence is executed.

### FIELD OF THE INVENTION

The present invention relates generally to printers and other printing devices.

### BACKGROUND

Various types of printers and printing devices exist that enable computer users to print text and graphics onto a print medium. An inkjet printer typically uses pens that have print heads and are filled with ink in order to deposit small droplets of ink through the print head onto the print medium. A laser printer generally uses a laser, optics, mirrors, and a heating unit to write text and graphics onto the print medium such that a toner powder is heated and fused to the medium's surface in the shape of the text and/or graphics.

These printers may be small consumer printers with minimal control input such as one or two buttons for loading pens or feeding paper. Large commercial or industrial printers may have multiple keys, keypads, or other input means that give the printer operator greater control over the printer output. These controls may include form feeds, moving media, cutting media, and changing the order of a print job in a print queue.

A problem with having a large number of function keys or buttons is that, in order for a printer operator to perform a complex printer control task, the operator typically has to make multiple keystrokes to enter the task. For example, the operator may want to change one of the print jobs in the queue to a higher priority as well as change the print media to be used while feeding the remaining print job medium out of the printer. This set of instructions may require three or more keystrokes to enter.

For the reasons stated above, and for other reasons stated below that will become apparent to those skilled in the art upon reading and understanding the present specification, there is a need in the art for a printer that reduces the number of keystrokes required to perform printer functions.

### SUMMARY

The present invention encompasses a printer that has at least one functional key that is programmable. The function of the functional key can be updated in response to an input functional sequence.

The printer further has memory that is capable of storing an indication of the updated functional sequence. A controller is coupled to the function key and the memory. The controller is adapted to control the operation of the printer such that the updated functional sequence is performed upon detection of an activation of the function key.

Further embodiments of the invention include methods and apparatus of varying scope.

### DESCRIPTION OF THE DRAWINGS

FIG. 1 is a block diagram of a printer in accordance with one embodiment of the present invention.

FIG. 2 is a perspective view of a printer in accordance with one embodiment of the present invention.

FIG. 3 is a flowchart of a key programming method in accordance with one embodiment of the present invention.

FIG. 4 is a flowchart of a key programming method in accordance with another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The subsequent discussion of the present invention refers to a printer as being the preferred use of the programmable function keys. Any reference to a printer encompasses any device that has a printing function such as facsimile machines or any combination unit incorporating a print function.

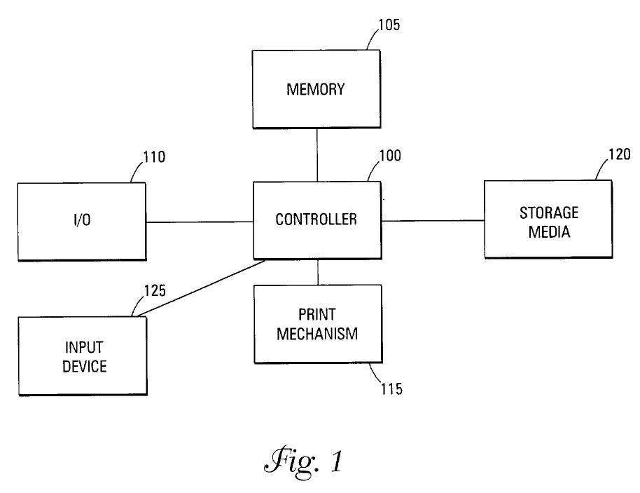

FIG. 1 illustrates a block diagram of one embodiment of a printing device of the present invention. The printer includes a controller 100 that controls the operation of the printer. The controller 100 may be a microprocessor or it may be a simpler microcontroller running microcode.

The printer memory 105 may be of the type used for temporary storage of data such as random access memory (RAM). Additionally, the memory 305 may be of the type used for permanent storage of data such as read only memory (ROM), programmable read only memory (PROM), and/or memory cards. Other types of memory, semiconductor or otherwise, can be included as memory.

The printer memory 105 may be used to store printing tasks that have been sent to the printer from one or more computers on a network, directly from a host computer, or by data downloaded from a memory card inserted into the printer. In one embodiment, the memory stores the firmware that is executed by the controller in order to control the operation of the printer. Additionally, the memory may store key or function sequences of the present invention. This key or function sequence information, in one embodiment, includes a sequence of printer functions to be performed as well as an identification of the key to which that sequence of functions is assigned.

The printer may be comprised of additional memory such as storage media 120. The storage media memory 120 can include hard disk drives, floppy disk drives, optical drives, removable solid-state memory cards, or any other type of storage media. The storage media 120 may be fixed or removable.

The input/output (I/O) connections 110 include any network interface cards required to interface the printer to a network (e.g., Ethernet). In another embodiment, the network connection 110 is simply a USB port, IEEE 1394 port (FIREWIRE), infrared, or other type of port for coupling the printer to a host device. The present invention is not limited to any one type of network or I/O connection.

In one embodiment, the print task or job may be sent to the printer over the I/O connection 10 in multiple packets of data. In another embodiment, the print job is transmitted over the I/O connection 110 in a serial bit stream of data. The present invention is not limited to any one means of data transport.

The controller 100 is also coupled to and controls the printer mechanisms 115 of the printer. For example, in an inkjet printer, the printer mechanisms II 5 include the inkjet pen(s), the pen carriage device(s), and the roller that feeds the paper through the printer. If the printer is a laser printer, the printer mechanisms 115 may include the toner cartridge, the various feed rollers, the laser mirrors and optics, and the thermal devices required for laser printing. In general, the printer mechanisms 115 are the mechanical components of the printer related to transporting the print media within the printer and transferring a tangible image to the print media.

An input device 125 such as a keypad, touch sensitive display (e.g., liquid crystal display, cathode ray tube), or other type of input device is coupled to the controller 100 to enable a printer user/operator to input commands or data to the printer controller 100.

The block diagram of FIG. 1 is for illustration purposes only. The programmable printer keys of the present invention are not limited to any one type of printer or any one printer functional configuration.

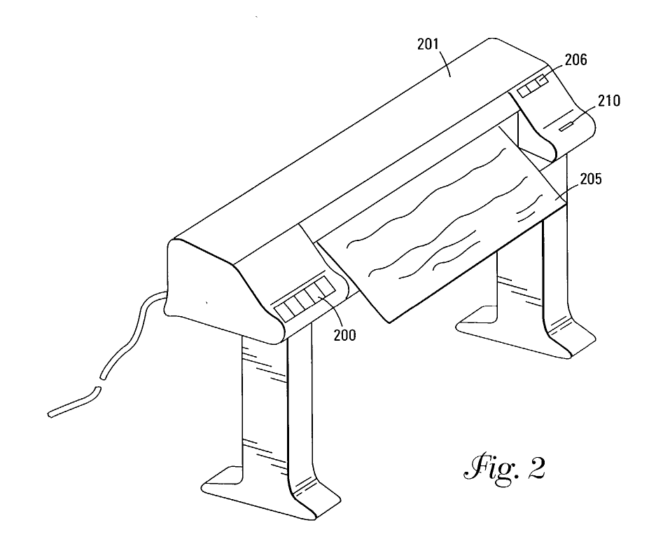

FIG. 2 illustrates a perspective view of one embodiment of the printer of the present invention. The printer includes a main body 201 that houses the electronics and other functions such as is illustrated in the embodiment of FIG. 1.

Print media 205 may be fed from the back of the main body 201 through the printer and output through an opening in the front of the main body 201. The print media 205 may be fed through the printer from rolls or sheets and of various sizes depending on the type of print job to be completed.

The main body 201 also has various function keys 200 and 206, switches, buttons, touch-sensitive displays, or other function control means for entering commands to the printer. Some function keys 206 may be used for applying power to the printer or other basic functions. Additional keys 200 may be used to provide more complex functional control of the printer. Any of these keys 200 and 206 can be reprogrammed according to one embodiment of the present invention. The subsequent discussion of the different embodiments of the present invention refers to a “key” as the means for controlling a certain printer function. The term “key” encompasses any of the control means previously discussed.

The main body 201, in one embodiment, has a slot 210 that accepts memory cards. The memory cards may be any type of memory such as semiconductor memory, optical memory, and magnetic memory. For example, the memory card may include a micro-hard drive. The memory cards can be inserted into the slot 210 in order to transfer text, images, or additional functionality for reprogramming keys as is discussed subsequently.

The printer of FIG. 2 is for illustration purposes only and does not limit the present invention to any one type of printer. The printer of FIG. 2 may be a commercial-type printer. Alternate embodiments of the present invention encompass smaller consumer-type printers.

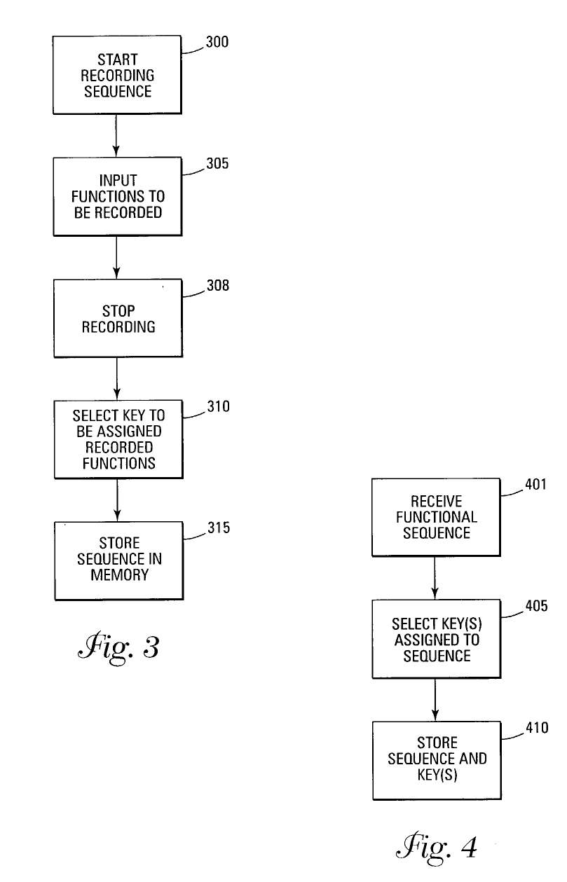

FIG. 3 illustrates a flowchart of one embodiment of a key programming method of the present invention. A recording session of the functions that are desired to be programmed and assigned to a certain programmable key is initiated at 300. This phase may be accomplished by activating a key, multiple keys simultaneously, a sequence of keys, or a menu function in order to start the recording function. As one example, the printer operator may hold down a “function” key while activating a second key that has a dual function. The second key may have a first function when activated by itself and a second, “start recording” function, when activated along with the “function” key. As another example, the imaging device may have a dedicated “record” key or menu choice to initiate the recording session. As yet another example, a sequence or pattern of keys may be used to initiate the recording session similar to using Ctrl-Alt-Del to reboot a personal computer.

The functions to be recorded and assigned to the programmable key are then entered 305 by a functional key sequence input. The assigned functionality may be a single function or a sequence of functions that are to be performed in a defined order. The printer operator may enter the desired functions by activating appropriate function keys in the order that the functions are to be recorded. The printer controller reads the functions that are being selected and stores these functions in memory.

In one embodiment, the recording session is stopped at this point 308. This can be accomplished by activating the same key or key sequence that started the recording. Other embodiments use other methods to stop the recording. As discussed subsequently, alternate embodiments may stop the recording at different locations instead of here.

The key or keys to which the new functionality is to be assigned is selected 310. This may include one key, multiple keys activated simultaneously, or a sequence of key activations. Selecting the key or keys to which the new functionality is to be assigned may be performed prior to recording the function key sequence. If there is only one programmable key available, the key may be selected by default.

In an alternate embodiment of the present invention the recording session is stopped at this point. In this embodiment, the last key activated prior to stopping the recording session is assumed to be the selected key to which the functional key sequence is assigned.

The recorded functional key sequence and the key(s) to which the sequence is assigned are stored in memory 315 for later use by the controller. This may require updating the firmware portion of the printer's memory. In another embodiment, the sequence and assigned key(s) are stored in FLASH RAM, electrically alterable read only memory (EAROM), electrically erasable read only memory (EEROM), or other memory. In still another embodiment, the information is stored on the printer's hard drive or other computer usable media.

The functional key sequence may be stored in a certain address range of the printer's memory. For example, one block of addresses in memory may be assigned to the “Clear” key. In this case, when the controller determines that the “Clear” key has been activated, it accesses that block of memory to determine what functions to perform. If the function of the “Clear” key has been reassigned through the methods of the present invention, the functions previously assigned to that key are overwritten by an indication of the new key sequence (i.e., the functional key sequence or an address pointer that points to the sequence). In another embodiment, a pointer in memory that is assigned to the “Clear” key is changed to point to the new key sequence.

Prior to assignment of the entered functional key sequence, the functional key may already have an assigned function. In another embodiment, the functional key has no function (i.e., a null function).

FIG. 4 illustrates a flowchart of another embodiment of the key programming method of the present invention. This embodiment encompasses a method for assigning different functionality to a programmable key by transferring the desired functional sequence through I/O connections.

The new functional sequence 401 to be assigned to a certain key or keys is received. In one embodiment, this key sequence is downloaded from a computer or other external device (e.g., personal digital assistant, palm computer) over a network or I/O connection. In another embodiment, the information is downloaded from the Internet through the I/O connections.

The functional sequence, in another embodiment, can be stored on a memory card that can then be inserted into the printer. The memory card may be comprised of electrical contacts that are inserted into electrical contacts within the printer. The printer's controller then has access to the memory card as it would access memory within the printer itself. Connection to and access of memory cards are well known in the art and are not discussed further.

The key or keys to which the new functional sequence is assigned are selected 405. This can be accomplished by prompting the user/operator to activate the desired key(s) or key sequence.

In another embodiment, the downloaded functional sequence may already be preassigned to a predetermined key or keys on the printer. This embodiment may also work for functional sequences that are received from a memory card. In either case, the new functional sequence may be preassigned to certain keys of the printer that were designed for being assigned new functionality. For example, three keys on the printer may have no function until a memory card is inserted, the functional sequences are downloaded, or the operator records a sequence. The functional sequences are then assigned to the keys to which the memory card or download file has been preprogrammed.

The new functional sequence and its assigned key(s) are stored 410 for future use by the printer controller. This phase encompasses the storing of new address pointers to point to the new key sequence. For example, if new key sequence on an inserted memory card is accessed directly instead of being downloaded to printer memory to update the firmware, an original address pointer that pointed to the old functionality may be updated to point to the new functionality on the memory card.

While one embodiment of the present invention has been described as assigning a functional key sequence to a programmable key of the printer, the present invention is not limited to the assignment of key functions. For example, a printer function that does not require or does not have a key for activation may also be assigned to a programmable key. This can be described as assigning a functional sequence to that key.

In one embodiment of the present invention, a means for controlling the printer could be the controller. Also in this embodiment, the means for receiving the functional sequence may be a network connection, a local I/O connection, a memory card reader, or the controller if the controller incorporates some type of I/O functionality (e.g., universal asynchronous receiver transmitter). This embodiment may also have means for assigning the functional sequence to a programmable function key that may include the controller. Additionally, a means for updating the firmware could include the controller that stores the functional sequence in memory.

### CONCLUSION

The programmable function keys and methods of the present invention provide a printer operator with the ability to program or reprogram the functions of certain keys on a printer so that those keys can be used as a short-cut to performing a function. As an example, instead of having to depress four keys to form feed media, cut the media, move a print job in the print queue, and clear a display, the operator can assign that sequence of functions to a single key. This reduces the need for the operator to consult manuals and constantly watch over the print job in order to perform successive tasks.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A printer comprising:
a function key having an assigned functional sequence that is changeable in response to an input functional sequence to create an updated functional sequence;
memory that is capable of storing an indication of the updated functional sequence; and
a controller coupled to the function key and the memory, the controller adapted to control operation of the printer such that the updated functional sequence is performed upon detection of an activation of the function key.

2. The printer of claim 1 wherein the assigned functional sequence is a null sequence.

3. The printer of claim 1 wherein the memory is on a memory card that is removable from the printer.

4. The printer of claim 1 wherein the indication of the updated functional sequence is a memory address pointer that points to the updated functional sequence.

5. The printer of claim 1 wherein the indication of the updated functional sequence is the functional sequence that was input.

6. The printer of claim 1 wherein the functional sequence comprises a sequence of one or more printer function key activations.

7. The printer of claim 1 wherein the functional sequence comprises a sequence of functions received from an external device.

8. The printer of claim 1 wherein the functional sequence comprises a functional sequence that has been retrieved from a memory card inserted into the printer.

9. The printer of claim 1 and further comprising an input/output connection coupled to the Internet to download the input functional sequence.

10. The printer of claim 1 and further comprising an input/output connection coupled to a computing device to download the input functional sequence.

11. A method of operating a printer, the method comprising:
recording a function sequence;
assigning the recorded function sequence to a function key of the printer, wherein the function key is programmable by a user/operator of the printer; and
performing the recorded function sequence by the printer in response to activation of the programmable function key.

12. A method of operating a printer, the method comprising:
starting a function key sequence recording session;
receiving a function key input sequence;
selecting the programmable function key to which the received function key input sequence is assigned; and
storing the received key function input sequence in memory such that activation of the programmable function key results in the received key function input sequence being performed.

13. The method of claim 12 wherein storing the received key function input sequence in memory comprises updating printer firmware in order to assign the received key function input sequence to the programmable function key.

14. The method of claim 12 and further including stopping the recording session after receiving the key function input sequence.

15. The method of claim 12 and further including stopping the recording session after selecting the programmable function key.

16. A method for updating a programmable function key in a printer having memory, the method comprising:
receiving a functional sequence;
assigning the functional sequence to the programmable function key; and
storing in memory an indication of the functional sequence with an indication of the programmable function key.

17. The method of claim 16 wherein receiving the functional sequence further comprises receiving the functional sequence from a memory card inserted into the printer.

18. The method of claim 16 wherein receiving the functional sequence further comprises receiving the functional sequence over a network connection.

19. The method of claim 16 wherein receiving the functional sequence further comprises receiving the functional sequence from activation of a plurality of function keys on the printer in a predetermined sequence.

20. A method for updating a plurality of programmable function keys in a printer having memory comprising firmware and a controller that executes the firmware, the method comprising:
receiving a functional sequence over a network connection;
selecting a first programmable function key of the plurality of programmable function keys to which the functional sequence is assigned;
assigning the functional sequence to the first programmable function key; and
updating the firmware with the functional sequence such that the controller executes the functional sequence when the first programmable function key is activated.

21. A printer comprising:
means for controlling the printer;
memory that stores firmware executable by the means for controlling;
a plurality of programmable function keys coupled to the means for controlling;
means for receiving a functional sequence;
means for assigning the functional sequence to a first programmable function key of the plurality of programmable function keys; and
means for updating the firmware with the functional sequence such that the means for controlling executes the functional sequence upon activation of the first programmable function key.

22. A printer, comprising:
means for receiving a user-defined functional sequence;
means for assigning the received user-defined functional sequence to a programmable function key of the imaging device; and
means for executing the received user-defined function sequence in response to an activation of the programmable function key.

23. The imaging device of claim 22, wherein the programmable function key is selected from a group consisting of a single key, a pattern of keys, a sequence of keys, a touch sensitive display option, and a menu choice.

24. A method for updating a programmable function key of a plurality of function keys in a printer having memory and a controller, the memory comprising firmware that is executable by the controller for controlling operation of the printer, the method comprising:
starting a function key sequence recording session in response to a received input of at least one function key;
receiving a function key input sequence from an activation of a first set of function keys of the plurality of function keys;
assigning the received function key input sequence to the programmable function key; and
updating the firmware with the received function key input sequence such that activation of the programmable function key results in the received function key input sequence being executed.

25. A printer comprising:
a plurality of function keys having at least one programmable function key adapted to receive a functional sequence;
memory adapted to store the functional sequence; and
a controller coupled to the plurality of functional keys and the memory, the controller adapted to control operation of the printer such that a functional sequence recording session is started and stopped upon activation of a first subset of the plurality of function keys, the controller also adapted to receive the functional sequence that is entered during the recording session by activation of a second subset of the plurality of function keys, the controller is further adapted to execute the assigned functional sequence upon detection of an activation of its associated programmable function key.

26. The printer of claim 25 wherein the memory includes random access memory, optical memory, and magnetic memory.
